(19) United States
(12) Patent Application Publication
(10) Pub. No.: US 2012/0036818 A1
(43) Pub. Date: Feb. 16, 2012

(54) FORAGE CROP PROCESSING APPARATUS

(76) Inventor: Jeffery D. Baird, Ada, OK (US)

(21) Appl. No.: 13/208,129

(22) Filed: Aug. 11, 2011

Related U.S. Application Data
(60) Provisional application No. 61/372,540, filed on Aug. 11, 2010.

(51) Int. Cl. A01D 61/00

(52) U.S. Cl. 56/16.4 B

(57) ABSTRACT

A forage crop processing apparatus having a cutting assembly for reaping the forage crop, a tubular drying channel having an inlet end for receiving the reaped forage crop, an air mover in fluid communication with the tubular drying channel to move air through the tubular drying channel in such a way that the forage crop is carried by the air through the tubular drying channel from the inlet end, past the interior heating surface, to the outlet end to produce a dried forage crop, and a baler connected to the outlet end of the tubular drying channel for baling the dried forage crops.

### CROSS REFERENCE TO RELATED APPLICATIONS

This application claims benefit to U.S. Provisional Application No. 61/372,540, filed Aug. 11, 2010, the entire contents of which are hereby incorporated herein by reference.

### BACKGROUND OF THE INVENTION

1. Field of the Invention

This invention relates to a forage crop processing apparatus, and more particularly, but not by way of limitation, to a forage crop processing apparatus which reaps a forage crop, dries the forage crop to produce a hay having a specified moisture content, and bales the hay for storage or use.

2. Brief Description of Related Art

Forage crops are plant material (mainly plant leaves and stems) eaten by grazing livestock. Forage crops are frequently grown and stored long-term for use during periods of time when forage crops are unable to grow, for example, during winter months. In general, methods for processing forage crops for storage involve several steps. Typically, the first step is to reap or cut the forage crop using a scythe, sickle or a mechanical reaper. Often times forage crops are reaped by a swather or windrower which, in addition to cutting the forage crop at the stem, aligns the reaped crop with the stem ends in oriented in the same direction.

Next, the reaped forage crops must be dried such that they retain only a specified amount of moisture. The ideal moisture content for baled forage crops ranges from approximately 15% to 20%. If there is too much moisture in the forage crop, the forage crop may mold or rot. Additionally, when moisture rich forage crops are baled the excess moisture can lead to the spontaneous combustion of baled forage crops. Conversely, if there is too little moisture in the forage crop, there can be significant nutrient loss. To control the moisture content in the forage crop, the crops are typically left in piles on the ground to dry for a specified amount of time. The piles of reaped forage crop are turned occasionally to aid in the drying process. Unfortunately, when forage crops are left exposed to the elements they may attract pests and inclement weather may make drying the forage crops an impossible task. Finally, once the forage crops have been dried they are compacted into bales, either round or rectangular, for storage.

Attempts have been made at constructing forage crop processing apparatuses which reap, dry and bale forage crops, but to Applicant's knowledge, all of these attempts have required the use of conveyor-type systems which transport the reaped crops through a drying apparatus where the forage crops are heated in order to dry the forage crop. Incidental heat caused by friction and sparks caused by metallic components of the conveyor-type systems used to communicate the forage crop can pose a significant fire danger.

Therefore, a need exists for a forage crop processing apparatus that reaps a forage crop, dries the forage crop to produce a hay having a specified moisture content, and bales the hay for storage or use. Additionally, the need exists for a forage crop processing apparatus which minimizes the use of moving mechanical parts to prevent fire hazards. It is to such a forage crop processing apparatus that the present invention is directed.

### BRIEF DESCRIPTION OF THE SEVERAL VIEWS OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are therefore not to be considered limiting of its scope, for the invention may admit to other equally effective embodiments. Further, the figures are not necessarily to scale and certain features and certain views of the figures may be shown exaggerated in scale or in schematic in the interest of clarity and conciseness.

FIG. 1 is a perspective view of a forage crop processing apparatus constructed in accordance with the present invention.

FIG. 2 is a side cross-sectional view of a tubular drying channel of the forage crop processing apparatus of FIG. 1.

FIG. 3 is a sectional view of the tubular drying channel of FIG. 2 taken along line 3-3.

FIG. 4 is a partial side elevational view of the forage crop processing apparatus of FIG. 1.

### DETAILED DESCRIPTION OF EXEMPLARY EMBODIMENT

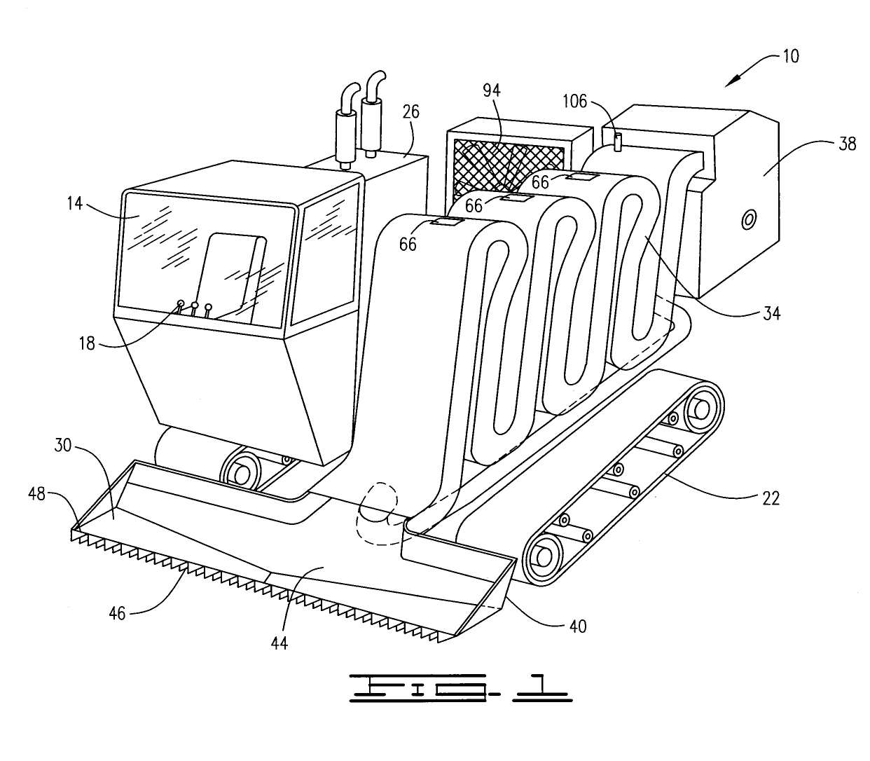

Referring now to the drawings and, more particularly to FIG. 1, shown therein is an apparatus 10 for processing forage crops. Although the apparatus 10 may be used to process any number of forage crops or grains, for purposes of clarity the apparatus 10 will be discussed for use with grasses used to produce hay. The apparatus 10 generally resembles a combine harvester and includes a cockpit 14 having a control system 18 for operating the various features of the apparatus 10. The apparatus 10 is supported by, for example, a pair of continuous tracks 22 or alternatively a plurality of ground engaging wheels (not shown). The various components of the apparatus 10 may be powered by a power plant 26 which may include, for example, an internal combustion engine and at least one hydraulic pump, although the apparatus 10 may optionally include an electric motor, or combinations thereof. As dried hay is extremely flammable, it will be understood that the use of hydraulic pumps to operate many of the mechanical parts of the apparatus 10 may decrease the fire hazard inherent in processing dried hay. The apparatus 10 also generally comprises a cutting member 30, a tubular drying channel 34 and a baler 38. The apparatus 10 reaps and directs the grass into the tubular drying channel 34 where it is carried through the tubular drying channel 34 via air produced by an air mover to remove moisture from the grass. The grass is then communicated to the baler 38 where it is compacted into bales.

The cutting member 30 includes a housing 40 having a lower scooping portion 44 and a plurality of reciprocating cutters 46 disposed along the front end 48 of the housing 40. Although the cutting member 30 has been disclosed as having a plurality of reciprocating cutters 46 the cutting member 30 may include any suitable device or devices which cut hay. Examples of such devices include, but are not limited to, rotating sickle bars, flail mowers, chains, rotary cutters and the like. Also, the cutting member 30 may incorporate a windrower or a swather portion which not only cuts the grass but also collects the individual pieces of grass together with the stem ends oriented in the same direction. Grass that is cut by the plurality of reciprocating cutters 46 is directed by lower scoop portion 44 of the housing 40 towards the tubular drying channel 34.

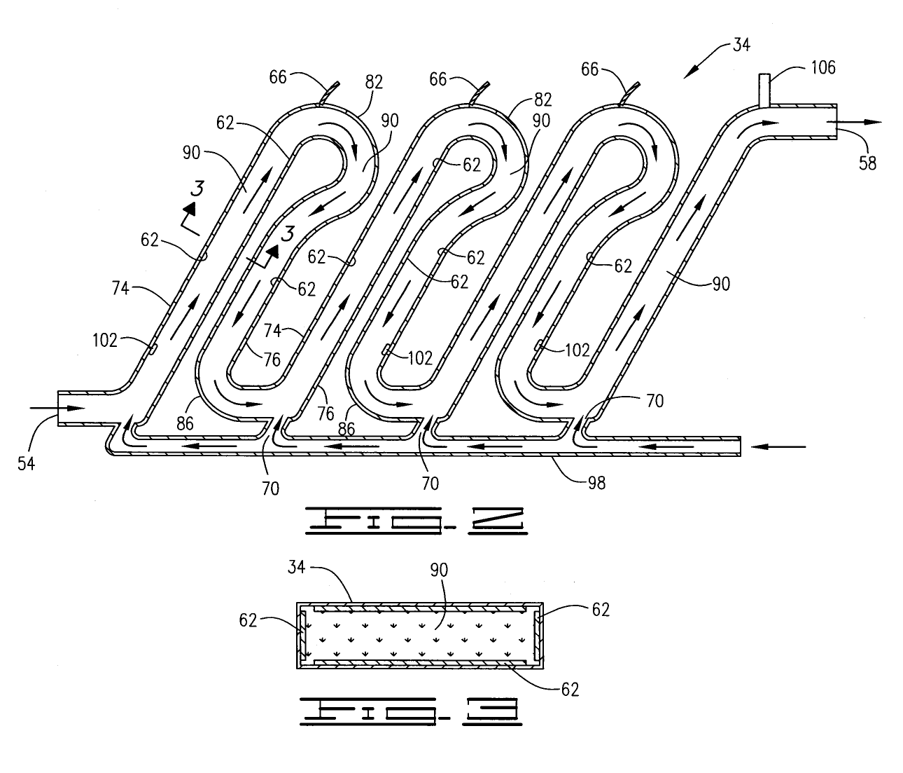

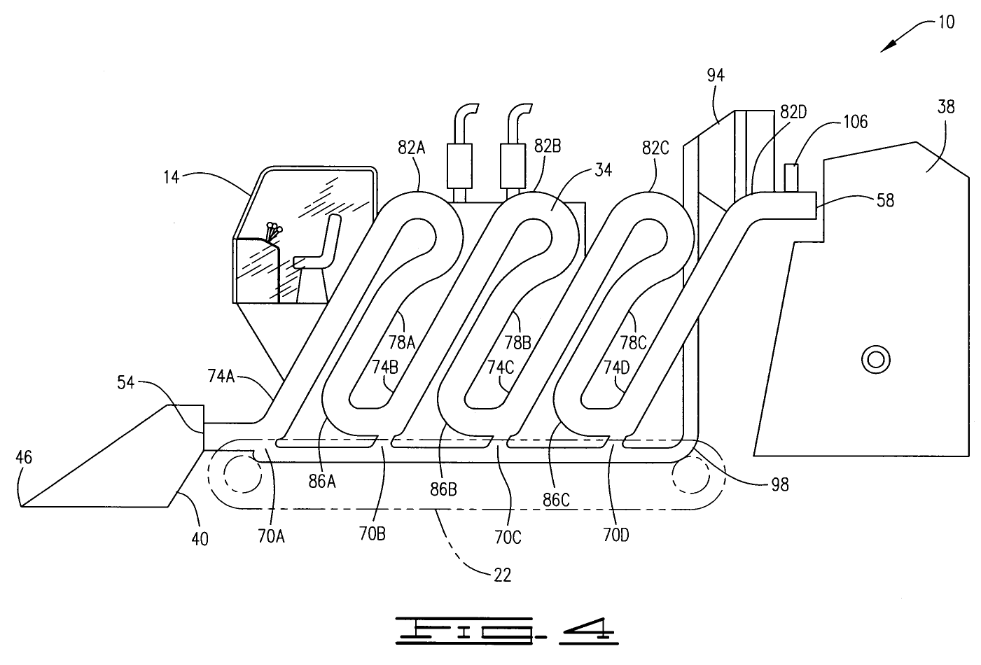

Referring now to FIGS. 2 and 3 collectively, the tubular drying channel 34 is provided as a vertically oriented, substantially rectangular tube disposed in a serpentine configuration. Although the tubular drying channel 34 has been disclosed as being vertically oriented and substantially rectangular, the tubular drying channel 34 may be oriented differently (e.g., horizontally, diagonally or angled) and may include any number of different geometrical configurations, for example, circular, triangular or irregular, that would be known to one of ordinary skill in the art with the present disclosure before them. It will be understood that the tubular drying channel 34 may be oriented with any number of other configurations rather than serpentine, for example, zig-zag, concentric, stacked, coiled or the like.

The tubular drying channel 34 generally includes an inlet end 54 for receiving grass from the cutting member 14, an outlet end 58 for communicating hay to the baler 38, interior heating surfaces 62 extending the length of the tubular drying channel 34, a plurality of selectively adjustable vents 66 and a plurality of air inlets 70. The tubular drying channel 34 may be divided into a plurality of substantially straight upward segments 74 connected to a plurality of fall segments 76 by upper arcuate connector segments 82 and lower arcuate connector segments 86. The apparatus 10 may include any number of segments 74, 76, 82 and 86, the number of which will vary according to design requirements.

The interior heating surfaces 62 are spaced apart from one another to define a heating region 90. It will be understood that the interior heating surfaces 62 may be an integral part of the tubular drying channel 34 or they may be separate from, but disposed within, the tubular drying channel 34. It will be further understood that the entire length of the tubular drying channel 34 may be considered the interior heating surfaces 62 or that only segments, for example, the substantially straight upward segments 74 or fall segments 78 may have interior heating surfaces 62. The interior heating surfaces 62 may include any number of different devices for raising the temperature of the air within the tubular drying channel 34. Non-limiting examples of interior heating surfaces 62 may include microwave heating devices, electric heating elements, infrared heating devices and the like.

The upper arcuate connector segments 82 may each include one of the plurality of selectively adjustable vents 66. The plurality of selectively adjustable vents 66 operate to allow moisture and excess air flowing through the tubular drying channel 34 to escape or be purged from the tubular drying channel 34. The amount of moisture and air allowed to escape via the plurality of selectively adjustable vents 66 may be varied according to operational requirements. The lower arcuate connector segments 86 may each include one of the plurality of air inlets 70. The air inlets 70 are positioned coaxially with and below the substantially straight upward segments 74. Each of the air inlets 70 receive air from an air mover, for example, a fan 94 and direct air from the fan 94 upwardly through the substantially straight upward segments 74. The fan 94 is connected to the air inlets 70 by a main duct 98 for distributing air to each of the air inlets 70. It will be understood that although the air mover has been disclosed as including the fan 94, any one of a number of air movers, including, but not limited to, blowers, impellers, turbines, vacuums and the like, that would be known to one of ordinary skill in the art with the present disclosure before them are likewise contemplated for use in accordance with the present invention.

As the fan 94 directs air through each of the plurality of air inlets 70, grass within the tubular drying channel 34 is carried upwardly by the air through the substantially straight upward segments 74 and around the upper arcuate connector segments 82. Gravity pulls the grass downwardly through the fall segments 76 where it collects in the lower arcuate connector segments 86. This operation is repeated, moving the grass successively through each of the segments until the grass reaches the outlet end 56 and exits the tubular drying channel 34. As the grass traverses through the tubular drying channel 34, the interior heating surfaces 62 raise the temperature of the both the grass and the air communicated from the fan 94 to remove moisture from the grass.

Moisture sensors 102 may be placed at various locations within the tubular drying channel 34 to measure the level of moisture within the grass so that the temperature within the tubular drying channel 34 or the volume and/or speed of air produced by the fan 94 may be adjusted accordingly. Also, the moisture sensors 102 may provide data which may partially govern the operation of the plurality of selectively adjustable vents 66 to control the amount of air and/or moisture escaping the tubular drying channel 34.

It will be understood that since the tubular drying channel 34 lacks mechanical parts, for example, gears, linkages, conveyors for communicating grass, the risk of fire from sparking and/or friction caused by mechanical parts is substantially reduced. Once the grass has completed its transit through the tubular drying channel 34, it can be baled for long term storage and/or immediate use. It will be understood that harvesting and storing grass with proper moisture concentration is essential to producing a high-quality hay. Hay should have a moisture concentration range from between 15% and 18% during the baling process. Hay baled at higher moisture levels is subject to heat damage, dry-matter loss, mold spoilage, and hay fires, and hay baled at lower moisture levels is subject to protein and total digestible nutrient losses. If a bale is to be stored outside, it will be understood that the moisture level of baled hay should preferably be below 22% to avoid potential spontaneous combustion of the bale.

The tubular drying channel 34 may optionally include an input valve 106 for introducing nutrients into the hay before it is communicated to the baler 38 for baling. The nutrients may include a liquid, solid or combination thereof of vitamins, minerals or a medicament which enhances the nutritional and/or medicinal value of the hay. It will be understood that the input valve 106 may be positioned at any location along the tubular drying channel 34.

The treated hay communicated out of the outlet end 58 of the tubular drying channel 34 is directed to the baler 38. The baler 38 is used to compress the cut and hay into bales and bind the bales with twine. It will be understood that typical balers may produce round or rectangular bales of hay. Although not shown, in the case of round bales, hay entering the baler 38 is compacted and rolled by a hay roller. The hay roller may include, for example, rubberized belts, fixed rollers, or a combination of rollers and belts for rolling the dried hay. Once the bale as reached a specified circumference, a twine or mesh is wrapped around the outside of the bale to secure the hay.

Additionally, although not shown, in the case of rectangular and/or square bales, the hay is cut to a substantially uniform length by a knife disposed near the front of the baler 38. The cut hay is moved by a fork towards the back of the baler 38 where it is compacted by a plunger. Once a bale is the correct thickness, a binding of twine or mesh is wrapped around the outside of the bale to secure the hay.

Referring now to FIG. 4, in operation, the apparatus 10 is traversed over a grassy field. The reciprocating cutters 46 of the cutting member 14 reap the grass, cutting it off at the stem. The lower scoop portion 44 of the housing 40 of the cutting member 14 directs the cut grass to the inlet end 54 of the tubular drying channel 34. Air communicated from the fan 94 through the first of a plurality of air inlets 70A carries the cut grass upwardly through the first substantially straight upward segment 74A and around the first upper arcuate connector segment 82A. Gravity causes the cut grass to travel downwardly through the first fall segment 78A where it collects in the first lower arcuate connector segment 86A. Air communicated through the second of a plurality of air inlets 70B carries the cut grass upwardly through the second substantially straight upward segment 74B and around the second upper arcuate connector segment 82B. Gravity causes the cut grass to travel downwardly through the second fall segment 78B where it collects in the second lower arcuate connector segment 86B. Air communicated through the third of a plurality of air inlets 70C carries the cut grass upwardly through the third substantially straight upward segment 74C and around the third upper arcuate connector segment 82C. Gravity causes the cut grass to travel downwardly through the third fall segment 78C where it collects in the third lower arcuate connector segment 86C. Air communicated through the fourth of a plurality of air inlets 70D carries the cut grass upwardly through the fourth substantially straight upward segment 74D and around a partial fourth upper arcuate connector segment 82D and out of the outlet end 58 of the tubular drying channel 34. As the grass is carried through the tubular drying channel 34, the interior heating surfaces 62 (see FIG. 2) raise the temperature of the both the grass and the air communicated from the fan 94 to remove moisture from the grass. Moisture sensors 102 (see FIG. 2) placed at various locations within the tubular drying channel 34 measure the level of moisture within the grass so that the temperature within the tubular drying channel 34 or the volume or speed of air produced by the fan 94, or the amount of air and/or moisture allowed to escape via the plurality of selectively adjustable vents 66 (see FIGS. 1 and 2) may be adjusted accordingly to produce hay having a predetermined level of moisture. If desired, a treatment material may be introduced to the dried hay via inlet valve 106. Once the grass has been dried into hay, the hay is baled by, for example, a rectangular baler 38 as discussed above.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A forage crop processing apparatus, comprising:
a cutting assembly for reaping the forage crop;
a tubular drying channel having an inlet end for receiving the reaped forage crop from the cutting member, an outlet end and an interior heating surface disposed between the inlet end and the outlet end;
an air mover in fluid communication with the tubular drying channel to move air through the tubular drying channel in such a way that the forage crop is carried by the air through the tubular drying channel from the inlet end, past the interior heating surface, to the outlet end to produce a dried forage crop; and
a baler connected to the outlet end of the tubular drying channel for baling the dried forage crops.

2. The apparatus of claim 1, wherein the tubular drying channel comprises:
a plurality of substantially straight upward segments each having a top and a bottom; and
a plurality of substantially straight fall segments, each having a top and a bottom;
wherein the top of each of the plurality of substantially straight upward segments is connected to the top of each of the plurality of substantially straight fall segments via an upper arcuate connector segment and wherein the bottom of each of the plurality of substantially straight upward segments is connected to the bottom of each of the plurality of substantially straight fall segments via a lower arcuate connector segment such that the tubular drying channel has a substantially serpentine configuration.

3. The apparatus of claim 2, wherein each of the lower arcuate connector segments includes an air inlet connected to the air mover, wherein each of the air inlets is positioned below and in axial alignment with the substantially straight upward segment.

4. The apparatus of claim 1, wherein each of the upper arcuate connector segments includes an selectively adjustable vent.

5. The apparatus of claim 1, further comprising a forage crop treatment apparatus connected to the tubular drying channel for introducing a treatment material to the forage crop.

6. The apparatus of claim 5, wherein the treatment material is selected from the group consisting of: a vitamin or combination of vitamins, a mineral or combination of minerals, a medicament, or combinations thereof.

7. The apparatus of claim 1, wherein the interior heating surface comprises two heating plates in spaced apart configuration, each of the heating plates disposed adjacently to an interior surface of the tubular drying channel.

8. The apparatus of claim 1, wherein the interior heating surface produces microwave radiation.

9. The apparatus of claim 1, wherein the interior heating surface produces infrared radiation.

10. An apparatus for drying a forage crop, comprising:
a tubular drying channel having an inlet end for receiving a reaped forage crop, an outlet end and an interior heating surface disposed between the inlet end and the outlet end;
an air mover in fluid communication with the tubular drying channel to move air through the tubular drying channel in such a way that the reaped forage crop is carried by the air through the tubular drying channel from the inlet end, past the interior heating surface, to the outlet end to produce a dried forage crop.

11. The apparatus for drying a forage crop of claim 10, wherein the tubular drying channel comprises:
a plurality of substantially straight upward segments each having a top and a bottom; and
a plurality of substantially straight fall segments, each having a top and a bottom;
wherein the top of each of the plurality of substantially straight upward segments is connected to the top of each of the plurality of substantially straight fall segments via an upper arcuate connector segment and wherein the bottom of each of the plurality of substantially straight upward segments is connected to the bottom of each of the plurality of substantially straight fall segments via a lower arcuate connector segment such that the tubular drying channel is disposed in a substantially serpentine configuration.

12. The apparatus of claim 1, wherein each of the lower arcuate connector segments includes an air inlet connected to the air mover, each of the air inlets positioned below and in axial alignment with the substantially straight upward segment.

13. The apparatus of claim 10, wherein each of the upper arcuate connector segments includes an selectively adjustable vent.

14. The apparatus of claim 10, further comprising a forage crop treatment apparatus connected to the tubular drying channel for introducing a treatment material to the forage crop.

15. The apparatus of claim 14, wherein the treatment material is selected from the group consisting of: a vitamin or combination of vitamins, a mineral or combination of minerals, a medicament, or combinations thereof.

16. A method for drying a forage crop, comprising the steps of:
reaping the forage crop;
directing the reaped forage crop into an inlet end of a tubular drying channel having a interior heating surface disposed between the inlet end and an outlet end thereof; and
transporting the reaped forage crop through the tubular drying channel via air communicated from an air mover in fluid communication with the tubular drying channel in such a way that a dried forage crop is produced.

17. The method of claim 16, further comprising the step of baling the dried forage crop.

18. The method of claim 16, further comprising the step of introducing a treatment material to the dried forage crop before the step of baling the dried forage crop.

19. The method of claim 18, wherein the treatment material is selected from the group consisting of: a vitamin or combination of vitamins, a mineral or combination of minerals, a medicament, or combinations thereof.
